(19) United States
(12) Patent Application Publication
(10) Pub. No.: US 2012/0324660 A1
(43) Pub. Date: Dec. 27, 2012

(54) PIPELINE PIG BRUSH

(75) Inventor: MICHAEL HOOPER, Chestermere (CA)

(73) Assignee: 766089 ALBERTA LTD., Calgary (CA)

(21) Appl. No.: 13/531,167

(22) Filed: Jun. 22, 2012

Related U.S. Application Data
(60) Provisional application No. 61/501,013, filed on Jun. 24, 2011.

(51) Int. Cl. F16L 55/26; A46D 3/04; A46B 15/00

(52) U.S. Cl. 15/104.061; 300/21

(57) ABSTRACT

A pipeline pig brush and method of assembly of the pipeline pig brush is provided. The pipeline pig brush has a body with a plurality of recesses provided in an outer surface. A number of brushes, each brush having a ferrule and a tuft of bristles, can be mounted to the body, wherein the ferrule of each brush is inserted into the recess and a removable fastener is installed to engage the body and overlap the ferrule such that the ferrule cannot be removed from the recess without removing the fastener.

### FIELD

The present invention relates to the field of pipeline pigs, which are devices for passing through pipelines to clean and/or inspect them.

### BACKGROUND

Most pipelines that carry fluids need to be “pigged” at certain times. This is accomplished by inserting a pig into the pipeline at a first point and allowing a driver, such as the force of fluids flowing through the pipeline, to move the pig through the pipeline to a second point where it is caught and removed from the pipeline.

Normally, pipeline pigs fall into two basic categories, non-intelligent pigs and intelligent pigs. Non-intelligent pigs are those that perform a maintenance or operational function, e.g. cleaning,—such as scraping of solids from the interior of the pipe; swabbing—such as removing liquids or gases from the pipeline; batching—such as separating different fluids in the pipeline, etc. Intelligent pigs are those that monitor and convey information about a particular condition or performance of the pipeline.

Such pigs include extensions of body material to ride against the interior surface of the pipe through which they are conveyed. Body extensions may include foam, rubber seals, bristles of a brush-like structure, etc. Such extensions may act to contact the pipeline inner wall to measure a wall parameter, provide electrical or magnetic contact between the pig and the wall, centralize the pig in the pipeline or scrape against the walls.

### SUMMARY

The present invention provides a new pipeline pig brush.

In accordance with one aspect of the present invention, there is a pipeline pig brush provided comprising: a body having an outer surface, the outer surface having formed therein at least one recess; at least one brush comprising a tuft of bristles and a ferrule, the ferrule retaining one end of the tuft of bristles, the at least one brush being mountable to the body by inserting the ferrule of the at least one brush into the at least one recess, and by installing a removable fastener to engage the body and overlap the ferrule, such that the ferrule cannot be removed from the at least one recess without removing the fastener.

In accordance with one aspect of the present invention, a pipeline pig brush is provided comprising: a body having an outer surface, the outer surface having formed therein a plurality of recesses; a plurality of brushes each comprising a tuft of bristles and a ferrule, the ferrule retaining one end of the tuft of bristles, the plurality of brushes being mountable to the body by inserting the ferrule of each of the plurality of brushes into one of the plurality of recesses, and by installing a removable fastener to engage the body and overlap the ferrule, such that the ferrule cannot be removed from the recess without removing the fastener.

In accordance with one aspect of the present invention, a method of assembling a pipeline pig brush is provided. The method comprises: providing a body having an outer surface, the outer surface having formed therein a plurality of recesses; providing a plurality of brushes, each of the plurality of brushes comprising a tuft of bristles and a ferrule, the ferrule retaining one end of the tuft of bristles; installing the ferrules of the plurality of brushes into the plurality of recesses; and securing the plurality of brushes into the plurality of recesses using removable fasteners.

It is to be understood that other aspects of the present invention will become readily apparent to those skilled in the art from the following detailed description, wherein various embodiments of the invention are shown and described by way of illustration. As will be realized, the invention is capable for other and different embodiments and its several details are capable of modification in various other respects, all without departing from the spirit and scope of the present invention. Accordingly the drawings and detailed description are to be regarded as illustrative in nature and not as restrictive.

### BRIEF DESCRIPTION OF THE DRAWINGS

Referring to the drawings, several aspects of the present invention are illustrated by way of example, and not by way of limitation, in detail in the figures, wherein:

FIG. 1 is an isometric view of a pipeline pig brush according to the present invention.

FIG. 2 is a side view of the pipeline pig brush of FIG. 1.

FIG. 3 is a top plan view of the pipeline pig brush of FIG. 1.

FIG. 4 is an end view of the pipeline pig brush of FIG. 1 installed in a pipe.

FIG. 5 is a section through an installed brush.

FIG. 6 is an isometric view, partially cut away, of a pencil brush useful in a pipeline pig brush.

FIG. 7 are views of a pig body useful in the present invention.

### DETAILED DESCRIPTION OF VARIOUS EMBODIMENTS

The description that follows, and the embodiments described therein, is provided by way of illustration of an example, or examples, of particular embodiments of the principles of various aspects of the present invention. These examples are provided for the purposes of explanation, and not of limitation, of those principles and of the invention in its various aspects. In the description, similar parts are marked throughout the specification and the drawings with the same respective reference numerals. The drawings are not necessarily to scale and in some instances proportions may have been exaggerated in order more clearly to depict certain features.

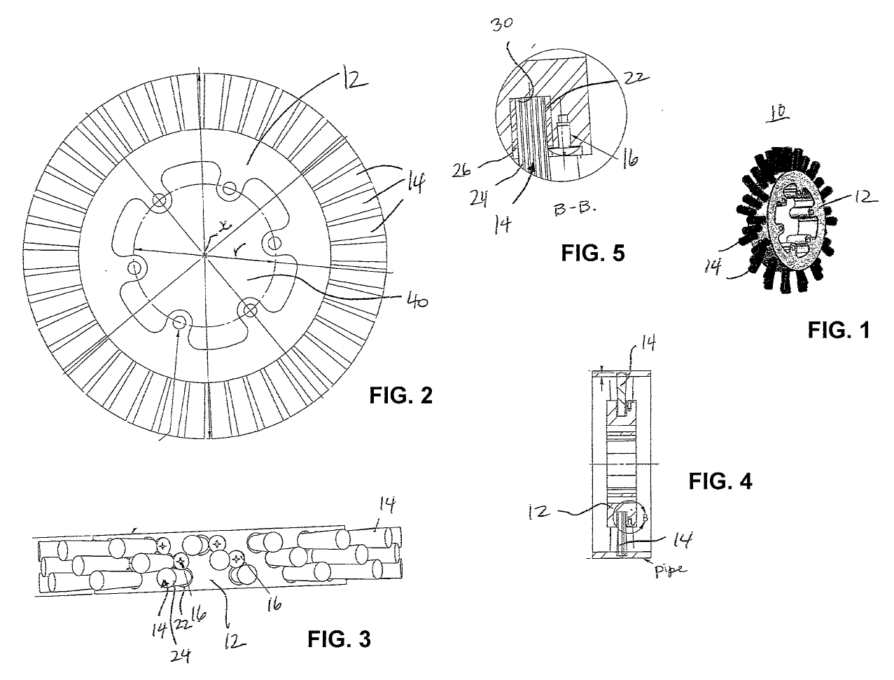

Reference will now be made to the Figures, which show various embodiments of the brush. A pipeline pig brush 10 according to one embodiment of the invention is shown in FIGS. 1 to 5. Such a brush 10 may include a body 12 and a plurality brushes 14 installed in the body by use of fasteners 16.

As noted above, the pipeline brush 10 further includes a plurality of brushes 14. Each brush 14 of the plurality of brushes 14 includes a ferrule 22 and a tuft of bristles 24 retained by the ferrule 22. A stepped portion 26 is formed between the ferrule 22 and the tuft of bristles 24, where the tuft of bristles 24 extends out from the ferrule 22.

Brushes 14 can be mounted to the body, wherein the ferrule of each brush is inserted into a recess 30 and removable fastener 16 is installed to engage the body and overlap the ferrule such that the ferrule cannot be removed from the recess without removing the fastener.

When the plurality of brushes 14 are installed and held in place by fasteners, tufts 24 of the plurality of brushes 14 extend out beyond the outer surface 12 of the body.

However, since fastener 16 is removable, a brush when worn can be removed from its recess and replaced.

The body includes one or more recesses 30 to accommodate brushes 14. Recesses 30 may each take various forms. In one embodiment, a recess 30 may accommodate more than one brush. Alternately, each recess 30 may be formed to accommodate only one brush 14, as shown. For example, in the illustrated embodiment, body 12 includes a plurality of recesses 30, each of which are small, cylindrically shaped and spaced apart and sized to only accommodate one brush ferrule. The plurality of recesses 30 in the illustrated embodiment, are spaced according to the arrangement of brushes desired for the pig. Recesses 30 may be spaced in close proximity to one another such that one fastener can overlap more than one ferrule, as shown for example in FIG. 3.

Recess 30 may be sized to closely resemble the shape of the ferrule to surround and thereby firmly hold any brush positioned therein substantially against moving out of position.

The depth of the recesses can be selected to accommodate the ferrule such that the fastener when secured thereover can overlie the ferrule stepped portion 26 between the outer surface of ferrule 22 and the outer surface of the tuft 24.

While the body is shown cylindrical, it may take other forms such as rounded or polygonal (i.e. square, triangular, octagonal, irregular, etc.), etc. While the brushes are shown as pencil brushes the brushes may be take other forms such a flat brush, etc. in which case the ferrule may be polygonal including square, triangular, rectangular, etc., in section. In such an embodiment, the recesses may be likewise shaped to accept the ferrule therein. The body may, as shown, include a substantially central mounting aperture 40 for permitting the mounting of the pipeline pig brush 10 on a tool mandrel. The tool mandrel may be a portion of pipeline pig that retains the pipeline pig brush 10. For example, the tool mandrel may be a mandrel that retains the brush 10, as by fasteners, welding, clamping, etc. and also includes a driver for the pig. The driver may include an active device such as a crawler or an inactive pressure driven device such as a seal cup (as shown), a foam plug, further brushes, etc.

To assemble a pipeline pig brush, the brushes may first be installed in their recesses in the body and the body then installed on the pipeline pig mandrel. For example, ferrules of brushes 14 may be placed in the recesses 30 and then fasteners installed to secure the brushes into the recesses. The brush 10 may be installed on a central mandrel of a pipeline pig. Further pig brushes (including body and brushes) may be added as desired.

The brushes 14 may be formed in various ways using a tuft 24 of bristles and a ferrule 22 such that stepped portion 26 is formed to be engaged by the fastener, with the head of the fastener overlying the stepped portion. Of course, any brush 14 may be sufficiently durable, with consideration as to pipeline conditions, such that it can withstand at least one pass through a pipeline substantially without breaking down, losing bristles, completely wearing away, or generally failing.

Because the recesses 30 act to accommodate the brushes 14 in the body, the recesses 30 can be formed to hold the brushes firmly in various orientations. For example, recesses 30 of the illustrated embodiment are formed with their center axis extending orthogonally from a radial line r relative to center axis x such that the brushes 14 are shown extending out radially from the body. However, recesses 30 can be formed to hold the brushes offset from a radially extending position, if desired.

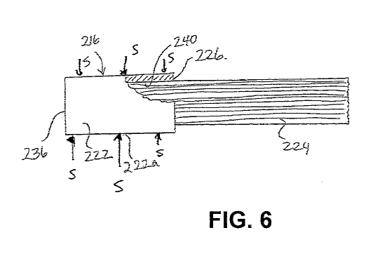

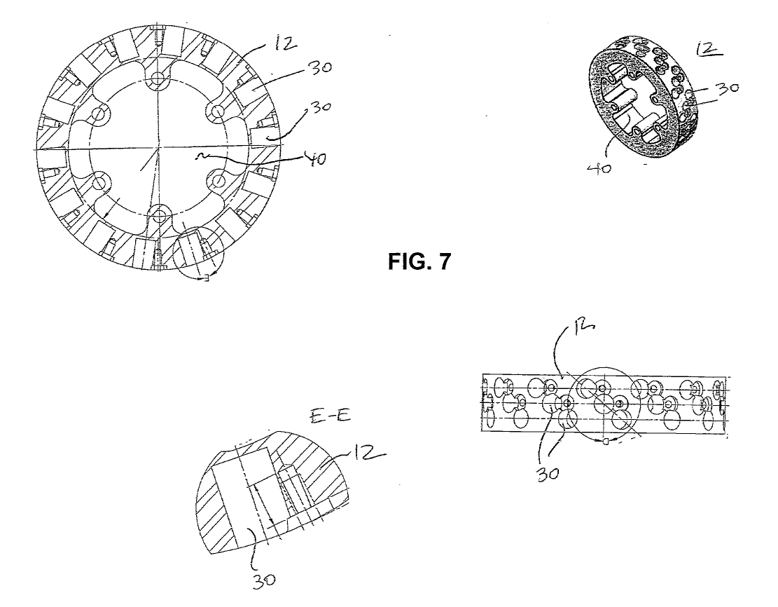

In some useful embodiments, the brush is formed by providing a ferrule, inserting a plurality of bristles therein and securing the bristles in the ferrule by welding, soldering, gluing and/or swaging. One example brush 216 is shown in FIG. 6, which includes a ferrule 222 and a tuft of bristles 224 secured therein. The thickness of the wall of the ferrule 222 creates stepped region 226.

Various options for brushes 216 and processes for producing them are described in applicant's earlier applications US 2007/0151055, published Jul. 5, 2007 and US 20050283930, published Dec. 29, 2005. These documents are incorporated herein by reference.

The previous description of the disclosed embodiments is provided to enable any person skilled in the art to make or use the present invention. Various modifications to those embodiments will be readily apparent to those skilled in the art, and the generic principles defined herein may be applied to other embodiments without departing from the spirit or scope of the invention. Thus, the present invention is not intended to be limited to the embodiments shown herein, but is to be accorded the full scope consistent with the claims, wherein reference to an element in the singular, such as by use of the article “a” or “an” is not intended to mean “one and only one” unless specifically so stated, but rather “one or more”. All structural and functional equivalents to the elements of the various embodiments described throughout the disclosure that are know or later come to be known to those of ordinary skill in the art are intended to be encompassed by the elements of the claims. Moreover, nothing disclosed herein is intended to be dedicated to the public regardless of whether such disclosure is explicitly recited in the claims. No claim element is to be construed under the provisions of 35 USC 112, sixth paragraph, unless the element is expressly recited using the phrase “means for” or “step for”.

We claim:

1. A pipeline pig brush comprising:
a body having an outer surface, the outer surface having formed therein at least one recess;
at least one brush comprising a tuft of bristles and a ferrule, the ferrule retaining one end of the tuft of bristles,
the at least one brush being mountable to the body by inserting the ferrule of the at least one brush into the at least one recess, and by installing a removable fastener to engage the body and overlap the ferrule, such that the ferrule cannot be removed from the at least one recess without removing the fastener.

2. The pipeline pig brush of claim 1, wherein a step portion is formed between the ferrule and the tuft of bristles and wherein the tuft of bristles extends out from the ferrule.

3. The pipeline pig brush of claim 2, wherein the removable fastener overlaps the step portion.

4. The pipeline pig brush of claim 1, wherein the removable fastener overlaps more than one ferrule.

5. The pipeline pig brush of claim 1, wherein the tuft of bristles extends out beyond the outer surface of the body.

6. The pipeline pig brush of claim 1, wherein the body forms a substantially central mounting aperture.

7. The pipeline pig brush of claim 1, wherein the body forms a substantially central mounting aperture, the mounting aperture having a central axis, and wherein the at least one recess has a central axis, and the at least one recess is formed having its central axis extending substantially orthogonally from the central axis of the mounting aperture, such that the tuft of bristles extends radially outwardly from the body.

8. The pipeline pig brush of claim 6, wherein the pipeline pig brush is mountable on a tool mandrel.

9. The pipeline pig brush of claim 7, wherein the pipeline pig brush is mountable on a tool mandrel.

10. The pipeline pig brush of claim 8, wherein the tool mandrel includes a driver.

11. The pipeline pig brush of claim 9, wherein the tool mandrel includes a driver.

12. The pipeline pig brush of claim 1, wherein only one brush is accommodatable in the at least one recess.

13. The pipeline pig brush of claim 1, wherein more than one brush are accommodatable in the at least one recess.

14. The pipeline pig brush of claim 1, wherein the at least one recess is cylindrically shaped.

15. The pipeline pig brush of claim 1, wherein the at least one recess is sized to closely resemble the shape of the ferrule.

16. The pipeline pig brush of claim 1, wherein the shape of the body is selected from the group consisting of cylindrical, square, triangular, octagonal, and irregular.

17. The pipeline pig brush of claim 1, wherein the at least one brush is a pencil brush or a flat brush.

18. The pipeline pig brush of claim 1, wherein the ferrule is polygonal in section.

19. A method of assembling a pipeline pig brush comprising:
providing a body having an outer surface, the outer surface having formed therein a plurality of recesses;
providing a plurality of brushes, each of the plurality of brushes comprising a tuft of bristles and a ferrule, the ferrule retaining one end of the tuft of bristles;
installing the ferrules of the plurality of brushes into the plurality of recesses; and
securing the plurality of brushes into the plurality of recesses using removable fasteners.

20. The method of claim 19, further comprising installing the pipeline pig brush on a central mandrel of a pipeline pig.

21. The method of claim 19, further comprising forming a step portion between the ferrule and the tuft of bristles.

22. The method of claim 19, further comprising engaging each of the removable fasteners with a step portion formed between the ferrule and the tuft of bristles.

23. The method of claim 22, wherein the engaging is accomplished by overlying a head of the removable fastener over the step portion.

24. The method of claim 22, wherein the removable faster engages more than one step portions.

25. The method of claim 19, wherein the tuft of bristles extends out beyond the outer surface of the body.

26. The method of claim 19, wherein the body forms a substantially central mounting aperture.

27. The method of claim 20, wherein the body forms a substantially central mounting aperture and the central mandrel extends through the mounting aperture.

28. The method of claim 26, wherein the mounting aperture has a central axis, and wherein the plurality of recesses, each having a central axis, are formed having their central axes extending substantially orthogonally from the central axis of the mounting aperture, such that the tuft of bristles extends radially outwardly from the body.

29. The method of claim 20, wherein the central mandrel includes a driver.

30. The method of claim 19, wherein only one brush is accommodatable in each of the plurality of recesses.

31. The method of claim 19, wherein more than one brush is accommodatable in each of the plurality of recesses.

32. The method of claim 19, wherein each of the plurality of recesses is cylindrically shaped.

33. The method of claim 19, wherein each of the plurality of recesses is sized to closely resemble the shape of the ferrule.

34. The method of claim 19, wherein the shape of the body is selected from the group consisting of cylindrical, square, triangular, octagonal, and irregular.

35. The method of claim 19, wherein the plurality of brushes are pencil brushes or flat brushes.

36. The method of claim 19, wherein the ferrule is polygonal in section.
